(19) United States
(12) Patent Application Publication
(10) Pub. No.: US 2013/0197144 A1
(43) Pub. Date: Aug. 1, 2013

(54) INKJET INK AND INK CARTRIDGE

(71) Applicants: Keita Katoh, Shizuoka (JP); Masaki Kudo, Shizuoka (JP); Tomohiro Nakagawa, Kanagawa (JP); Akihiko Gotoh, Kanagawa (JP)

(72) Inventors: Keita Katoh, Shizuoka (JP); Masaki Kudo, Shizuoka (JP); Tomohiro Nakagawa, Kanagawa (JP); Akihiko Gotoh, Kanagawa (JP)

(21) Appl. No.: 13/755,601

(22) Filed: Jan. 31, 2013

(30) Foreign Application Priority Data
Jan. 31, 2012 (JP) 2012-17647

(51) Int. Cl. C09D 11/00

(52) U.S. Cl. CPC C09D 11/30
USPC 524/378; 524/386

(57) ABSTRACT

An inkjet ink is provided, containing: water; a water-soluble organic solvent; a colorant comprising a resin coating type colorant; and a resin emulsion comprising an anionic polyurethane resin emulsion, wherein the inkjet ink in an initial state has an average particle diameter D50(INI), and the inkjet ink in a dried state having 60% by mass of the initial state has an average particle diameter D50(60%), such that the inkjet ink satisfies the following formula:

1.00≦D50(60%)/D50(INI)<1.30.

### CROSS-REFERENCE TO RELATED APPLICATIONS

This patent application is based on and claims priority pursuant to 35 U.S.C. §119 to Japanese Patent Application No. 2012-17647, filed on Jan. 31, 2012, in the Japan Patent Office, the entire disclosure of which is hereby incorporated by reference herein.

### FIELD OF THE INVENTION

The present invention relates to an inkjet ink, and ink cartridge.

### BACKGROUND OF THE INVENTION

Dye inks are used for inkjet recording, wherein the dye inks include an aqueous dye ink, in which a dye is dissolved in an aqueous solvent, and a solvent dye ink, in which an oil-soluble dye is dissolved in an organic solvent.

The solvent dye ink may not be suitable for office use or household use in terms of environmental aspects, because solvent dye ink includes an organic solvent.

Meanwhile, a generic aqueous dye ink may not be sufficient in terms of water-resistance property and light resistance property, because the dye is used as a water soluble colorant.

To solve these problems, aqueous pigment ink having a pigment dispersed in an aqueous solvent is partly used, wherein the pigment has sufficient water-resistance property and light resistance property.

The aqueous pigment ink for inkjet recording contains a lower amount of a dispersant resin than other aqueous pigment inks for other recording methods, in order to ensure jetting stability and preservation stability. In addition, most of the pigment does not penetrate into the ink absorbing layer of an inkjet recording sheet and remains on the sheet to form a coating film. Therefore, when an aqueous pigment ink is used for an inkjet recording sheet, the printed image may have lower gloss or lower abrasion-resistance than when an aqueous pigment ink is used for a plain paper or when a dye ink that easily penetrates into the ink absorbing layer is used. In this case, the printed image may not have adequate quality due to peeling of the coating film to cause ambient defacement, when the printed image is scratched.

To resolve the aforementioned problem, other inkjet inks have been proposed.

For example, Japanese Patent Application Laid-Open (JP-A) No. 2002-97390, discloses an ink jet recording liquid. The ink jet recording liquid contains at least (a) carbon black having an average primary particle diameter of ≦18 nm and a Dbp oil-absorption of <120 cm3/100 g, (b) a polymer having amide bond and/or urethane bond and (c) water. The ink jet recording liquid is used for recording on a recording sheet having an ink receptor layer composed of a porous layer having an average pore diameter of ≦1 μm on at least one surface of a substrate.

JP-A No. 2009-67831 discloses a carbon black dispersion containing at least carbon black, a dispersant, and water, where the dispersant principally comprises alkali metal salt and/or organic base salt of naphthalenesulfonate formalin condensate, while in the carbon black, (i) a BET specific surface area is 80-130 m²/g, (ii) a mean particle diameter of primary particles is 22-28 nm, and (iii) a pH value is 3-6.

Even when the inkjet ink has high storage stability, when the inkjet ink in head nozzles of inkjet printer is dried due to decrease in the amount of water, jetting stability may decrease due to an increase of viscosity and aggregation of the inkjet ink at the head nozzles.

### BRIEF SUMMARY OF THE INVENTION

Accordingly, one object of the present invention is to provide an inkjet ink that maintains high abrasion-resistance, even when the amount of the resin emulsion is low.

A further object of the present invention is to provide an inkjet ink that maintains high jetting stability even when the inkjet ink is dried due to water evaporation, because aggregation of the pigment is reduced.

These and other objects of the present invention, either individually or in combinations thereof, have been satisfied by the discovery of an inkjet ink comprising:

water;

a water-soluble organic solvent;

a colorant comprising a resin coating type colorant; and

a resin emulsion comprising an anionic polyurethane resin emulsion,

wherein an average particle diameter of the inkjet recoding ink in initial state D50 (INI), and the average particle diameter of the inkjet ink in dried state D50(60%), having 60% by mass of the initial state, satisfies following the following formula:

1.00≦D50(60%)/D50(INI)<1.30;

and an inkjet cartridge containing the inkjet ink.

### BRIEF DESCRIPTION OF THE DRAWINGS

FIG. 1 shows a perspective view of the inkjet recording apparatus.

FIG. 2 schematically shows an example of an entire construction of the inkjet recording apparatus.

FIG. 3 schematically shows an enlarged view of an example of an inkjet head suitable for use in the inkjet recording apparatus.

FIG. 4 schematically shows an example of a casing of an ink cartridge.

FIG. 5 schematically shows an exterior of the ink cartridge of FIG. 4 including the casing thereof.

### DETAILED DESCRIPTION OF THE INVENTION

The present invention relates to an inkjet ink comprising:

water;

a water-soluble organic solvent;

a colorant comprising a resin coating type colorant; and

a resin emulsion comprising an anionic polyurethane resin emulsion,

wherein an average particle diameter of the inkjet recording ink in initial state D50 (INI), and the average particle diameter of the inkjet ink in dried state D50(60%), having 60% by mass of the initial state, satisfies following the following formula:

1.00≦D50(60%)/D50(INI)<1.30.

In a preferred embodiment of the present invention inkjet ink, the average particle diameter of the inkjet recording ink in initial state D50 (INI), and the average particle diameter of the inkjet ink in dried state D50(60%), having 60% by mass of the initial state, preferably satisfies the following formula:

1.00≦D50(60%)/D50(INI)<1.10

The inkjet ink of the present invention preferably has a viscosity of 5 mPa·s to 12 mPa·s.

In the present invention inkjet ink, the resin emulsion is preferably present in an amount of from 0.10% by mass to 1.00% by mass.

In a further preferred embodiment, the inkjet ink of the present invention further comprises 0.1% by mass to 3.0% by mass of a fluorine surfactant.

In the inkjet ink of the present invention, the colorant preferably comprises not more than 45% by mass of a pigment, wherein the pigment is selected from a self-dispersion type pigment, and the pigment is dispersed in an aqueous solvent by a high molecular weight dispersant or a surfactant.

The present invention further relates to an ink cartridge comprising: a container containing the inkjet ink of the present invention.

The inkjet ink of the present invention preferably has high jetting stability, which provides images having high abrasion-resistance. In addition the present invention provides an inkjet ink which preferably provides high quality images having high image density and decreased bleeding.

Preferred embodiments of the present invention will be described in detail.

The inkjet ink of the present invention comprises water; a water-soluble organic solvent; a colorant comprising a resin coating type colorant; and a resin emulsion including an anionic polyurethane resin emulsion, wherein an average particle diameter of the inkjet recording ink in initial state D50 (INI), and the average particle diameter of the inkjet ink in dried state D50 (60%), having 60% by mass of the initial state, satisfies the following formula:

1.00≦D50(60%)/D50(INI)<1.30.

The value of D50(60%)/D50(INI) is preferably less than 1.10. When the value is not less than 1.30, coagulation power becomes stronger due to evaporation of water that causes a decrease of the jetting stability.

### <Resin Emulsion>

An anionic polyurethane resin emulsion is used for the resin emulsion.

The polyurethane emulsion is preferably an O/W type emulsion, wherein the O/W type emulsion includes, but is not limited to, an emulsion prepared from a polyurethane resin using an emulsifying agent, and a self-emulsification type emulsion obtained by introducing a functional group acting as an emulsifying agent.

Among them, a self-emulsification type emulsion is preferred in terms of high dispersion stability in combination with the pigment and the dispersant, and particularly, an ether type polyurethane resin emulsion is preferred in terms of fixing property of the pigment or dispersion stability.

The amount of the resin emulsion in the inkjet ink is preferably 0.10% by mass to 1.00% by mass, more preferably 0.50% by mass to 0.70% by mass. When the amount of the resin emulsion is less than 0.10% by mass, the abrasion-resistance may decrease. When the amount of the resin emulsion is more than 1.00, the image density may decrease.

The weight-average molecular weight of the polyurethane emulsion is preferably 1.3×10⁴ to 3.0×10⁴. When the weight-average molecular weight is less than 1.3×10⁴, the abrasion-resistance may decrease. When the weight-average molecular weight is more than 3.0×10⁴, the jetting stability of the inkjet ink may decrease.

In the present invention, the weight-average molecular weight and the number average molecular weight of the polyurethane emulsion are preferably measured as polystyrene equivalent by gel permeation chromatography (GPC) using N-methylpyrrolidone as a developing solvent.

Suitable polyurethane emulsions for use in the present invention include, but are not limited to, SF460, SF460S, SF420, SF110, SF300, and SF361, manufactured by Nippon Unicar Company Limited; VONDIC series emulsions, manufactured by DIC Corporation; and TAKELAC W, TAKELAC WS series emulsions, W5025, and W5661, manufactured by Mitsui Chemicals Ink.

The anionic polyurethane emulsion may be used in combination with one or more other types of resin emulsions. Suitable other resin emulsions include, but are not limited to, acrylic resin emulsions, styrene-acrylic resin emulsions, silicone-acrylic resin emulsions, and fluorine resin emulsions. The total amount of the one or more other resin emulsions is less than 30% by mass based on the total amount of the resin emulsion.

Suitable styrene-acrylic resin emulsions include, but are not limited to, J-450, J-734, J-7600, J-352, J-390, J-7100, J-741, J74J, J-511, J-840, J-775, HRC-1645, and HPD-71, manufactured by Johnson Polymer.

Suitable silicone-acrylic resin emulsions include, but are not limited to, UVA383MA, manufactured by BASF; and AP4710, manufactured by SHOWA HIGHPOLYMER CO., LTD.

Suitable fluorine resin emulsions include, but are not limited to, FE4300, FE4500, and FE4400, manufactured by ASAHI GLASS CO., LTD.

### <Colorant>

In the present invention inkjet ink, a resin coating type colorant is used for the colorant. In the context of the present invention, the term “resin coating type colorant” refers to a colorant having some or all of the pigment colorant surface coated with a resin. The resin coating type colorant is stably dispersible without using a dispersant by coating the pigment with resin having a hydrophilic group to form a microcapsule.

Examples of the resin which coats the pigment, include, but are not limited to, polyamide, polyurethane, polyester, polyurea, epoxy resin, polycarbonate, urea resin, melamine resin, phenol resin, polysaccharides, gelatin, Arabian gum, dextran, casein, protein, natural rubber, carboxy polymethylene, polyvinyl alcohol, polyvinyl pyrrolidone, polyvinyl acetate, polyvinyl chloride, polyvinylidene chloride, cellulose, ethylcellulose, methylcellulose, nitrocellulose, hydroxyethylcellulose, cellulose acetate, polyethylene, polystyrene, polymer or copolymer of (meth)acrylic acid, polymer or copolymer of (meth)acrylate, (meth)acrylic acid-(meth)acrylate copolymer, styrene-(meth)acrylic acid copolymer, styrene-maleic acid copolymer, sodium alginate, fatty acid, paraffin, bees wax, insect wax, cured beef tallow, carnauba wax, and albumin.

Among them, organic polymers having one or more anionic groups, such as a carboxylic acid group and/or a sulfonic acid group, are preferably used.

Moreover, a nonionic organic polymer may be used as the resin. Examples of the nonionic organic polymer include, but are not limited to, polyvinyl alcohol, polyethyleneglycol monomethacrylate, polypropyleneglycol monomethacrylate, polymers or copolymers thereof, and a polymer formed by a cationic ring-opening reaction using 2-oxazoline. Particularly, fully saponified polyvinyl alcohol is preferred in terms of having low water solubility, which is not soluble in cold water but soluble in hot water.

The organic polymer forms a wall film of the microcapsule of the resin coating type colorant. The amount of the organic polymer is preferably 15% by mass to 40% by mass. When the amount is not more than 40% by mass, the chromogenic property may not decrease, because the amount of the organic polymer is relatively low in the microcapsule, and then the organic polymer does not coat the surface of the pigment too much. When the amount is less than 15% by mass, the effect of the microcapsulation may not be obtained. When the amount is more than 40% by mass, the chromogenic property may decrease.

The pigment in the present invention resin coating type colorant is preferably carbon black or a color pigment. Examples of the carbon black include, but are not limited to, those manufactured by furnace method and channel method, having a primary diameter of 15 μm to 40 μm, a BET specific surface area of 50 m²/g to 300 m²/g, a DBP absorption amount of 40 ml/100 g to 150 ml/100 g, a volatile portions of 0.5% to 10%, and a pH of 2 to 9.

Suitable examples of the carbon blacks include, but are not limited to, No. 2300, No. 900, MCF-88, No. 33, No. 40, No. 45, No. 52, MA7, MA8, MA100, and No. 2200B, manufactured by Mitsubishi Chemical Corporation; RAVEN 700, RAVEN 5750, RAVEN 5250, RAVEN 5000, RAVEN 3500, and RAVEN 1255, manufactured by Columbian Carbon Japan, Ltd.; REGAL 400R, REGAL 330R, REGAL 660R, MOGUL L, MONARCH 700, MONARCH 800, MONARCH 880, MONARCH 900, MONARCH 1000, MONARCH 1100, MONARCH 1300, and MONARCH 1400, manufactured by Cabot Corporation; and COLOR BLACK FW1, COLOR BLACK FW2, COLOR BLACK FW2V, COLOR BLACK FW18, COLOR BLACK FW200, COLOR BLACK S150, COLOR BLACK S160, COLOR BLACK 5170, PRINTEX 35, PRINTEX U, PRINTEX V, PRINTEX 140U, PRINTEX 140V, SPECIAL BLACK 6, SPECIAL BLACK 5, SPECIAL BLACK 4A, and SPECIAL BLACK 4, manufactured by Degussa. The carbon black is not limited to any of these examples.

Suitable examples of the color pigment include, but are not limited to, anthraquinone, phthalocyanine blue, phthalocyanine green, diazo, monoazo, pyranthrone, perylene, heterocyclic yellow, quinacridone, and (thio)indigo. Suitable examples of phthalocyanine blue include, but are not limited to, cupper phthalocyanine blue and a derivative thereof (Pigment Blue 15). Suitable examples of quinacridone include, but are not limited to, Pigment Orange 48 and Pigment Orange 49; Pigment Red 122, Pigment Red 192, Pigment Red 202, Pigment Red 206, Pigment Red 207, and Pigment Red 209; and Pigment Violet 19 and Pigment Violet 42. Suitable examples of anthroquinone include, but are not limited to, Pigment Red 43, Pigment Red 194 (perynone red), Pigment Red 216 (pyranthrone bromide red), and Pigment Red 226 (pyranthrone red). Suitable examples of perylene include, but are not limited to, Pigment Red 123 (vermilion), Pigment Red 149 (scarlet), Pigment Red 179 (marron), and Pigment Red 190 (red), Pigment Violet, Pigment Violet 189 (yellow shaded red), and Pigment Violet 224. Suitable examples of thioindigo include, but are not limited to, C.I. Pigment Red 86, Pigment Red 87, Pigment Red 88, Pigment Red 181, and Pigment Red 198, Pigment Violet 36, and Pigment Violet 38. Suitable examples of heterocyclic yellow include, but are not limited to, Pigment Yellow 117 and Pigment Yellow 138. Other examples of suitable pigments are listed in “The Color Index, the third revision, The Society of Dyers and Colorists, 1982”.

In the present invention, a self-dispersion type organic pigment or self-dispersion type carbon black is preferred for the colorant, because even if the capsule contains a small amount of the organic polymer, the pigment has high dispersibility to ensure preservation stability.

The average particle diameter of the pigment is not particularly limited and can be appropriately selected depending on the purpose. The average particle diameter of the pigment is preferably 10 nm to 150 nm, more preferably 20 nm to 100 nm, even more preferably 30 nm to 80 nm. When the average particle diameter is more than 150 nm, the intensity of printed images may decrease, in addition viscosity increase or aggregation of the inkjet ink may arise during preservation, or clogging of the nozzle may arise in ejecting the inkjet ink. When the average particle diameter is less than 10 nm, light resistance and preservation stability tend to decrease.

The average particle diameter of the pigment may be measured by UPA-EX150 manufactured by NIKKISO CO., LTD. In this case, the pigment is diluted to 0.01% by mass by using purified water to prepare the measurement sample. The average particle diameter means 50% average particle diameter (D50), wherein the measurement sample is measured at 23° C. using a particle refraction index of 1.51, a particle density of 1.4 g/cm³, and solvent parameter of purified water.

A pigment is preferably used as the colorant in the resin coating type colorant. However, a dye may be also used as the colorant in the resin coating type colorant. In that case, a dye having high water-resistance property or light-resistance property is preferably used. Examples of suitable dyes having water solubility are shown below, and include, but are not limited to, acid dyes, edible dyes, direct dyes, basic dyes, and reactive dyes.

Suitable examples of acid dyes and edible dyes include, but are not limited to, C.I. Acid Yellow 17, 23, 42, 44, 79, and 142; C.I. Acid Red 1, 8, 13, 14, 18, 26, 27, 35, 37, 42, 52, 82, 87, 89, 92, 97, 106, 111, 114, 115, 134, 186, 249, 254, and 289; C.I. Acid Blue 9, 29, 45, 92, and 249; C.I. Acid Black 1, 2, 7, 24, 26, and 94; C.I. Food Yellow 3, and 4; C.I. Food Red 7, 9, and 14; and C.I. Food Black 1, and 2.

Suitable examples of direct dyes include, but are not limited to, C.I. Direct Yellow 1, 12, 24, 26, 33, 44, 50, 86, 120, 132, 142, and 144; C.I. Direct Red 1, 4, 9, 13, 17, 20, 28, 31, 39, 80, 81, 83, 89, 225, and 227; C.I. Direct Orange 26, 29, 62, and 102; C.I. Direct Blue 1, 2, 6, 15, 22, 25, 71, 76, 79, 86, 87, 90, 98, 163, 165, 199, and 202; and C.I. Direct Black 19, 22, 32, 38, 51, 56, 71, 74, 75, 77, 154, 168, and 171.

Suitable examples of basic dyes include, but are not limited to, C.I. Basic Yellow such as 1, 2, 11, 13, 14, 15, 19, 21, 23, 24, 25, 28, 29, 32, 36, 40, 41, 45, 49, 51, 53, 63, 64, 65, 67, 70, 73, 77, 87, and 91; C.I. Basic Red 2, 12, 13, 14, 15, 18, 22, 23, 24, 27, 29, 35, 36, 38, 39, 46, 49, 51, 52, 54, 59, 68, 69, 70, 73, 78, 82, 102, 104, 109, and 112; C.I. Basic Blue 1, 3, 5, 7, 9, 21, 22, 26, 35, 41, 45, 47, 54, 62, 65, 66, 67, 69, 75, 77, 78, 89, 92, 93, 105, 117, 120, 122, 124, 129, 137, 141, 147, and 155; and C.I. Basic Black 2, and 8.

Suitable examples of reactive dyes include, but are not limited to, C.I. Reactive Black 3, 4, 7, 11, 12, and 17; Reactive Yellow 1, 5, 11, 13, 14, 20, 21, 22, 25, 40, 47, 51, 55, 65, and 67; C.I. Reactive Red 1, 14, 17, 25, 26, 32, 37, 44, 46, 55, 60, 66, 74, 79, 96, and 97; and Reactive Blue 1, 2, 7, 14, 15, 23, 32, 35, 38, 41, 63, 80, and 95.

In encapsulating a water insoluble pigment to be coated by an organic polymer, any process may be used. Such process includes, but is not limited to, chemical processes, physical processes, physicochemical processes, and mechanical processes. More specifically, interfacial polymerization, in-situ polymerization, in-liquid curing (orifice process), coacervation (phase separation), in-liquid drying, melting/dispersing/cooling, air-suspension coating (spouted bed coating), spray drying, acid catalyzing, and phase inversion emulsion.

The interfacial polymerization process includes dissolving two monomers or two reactants into a dispersed phase or a continuous phase respectively, and inducing reaction of the materials at their interfaces to form a wall. The in-situ polymerization process includes supplying a monomer and a catalyst in liquid or gas state, or two types of reactive materials, from one side of continuous phase or nuclear particle, and inducing reaction to form a wall. The in-liquid curing process includes insolubilizing polymer solution droplets, containing core material particles, in liquid by using a curing agent to form a wall.

The coacervation (phase separation) process includes separating polymer dispersion liquid, containing core material particles, into a coacervate (high concentration phase) having a high level of polymer concentration and a dilute phase to form a wall. The in-liquid drying process includes preparing a dispersion liquid containing the core material, introducing the dispersion liquid into a liquid that does not mix with the continuous phase of the dispersion liquid to produce a composite emulsion, and gradually removing the solvent into which the wall material is dissolved to form a wall.

The melting/dispersing/cooling process includes using a wall material that melts when heated but solidifies at normal temperatures, heating to melt this wall material, dispersing core material particles in the wall material to make fine particles, and cooling the fine particles to form the wall. The air-suspension coating process includes suspending core material particles in powder form in air using a fluidized bed, and maintaining the particles in an air-borne state while spray mixing a coating liquid of the wall material to form the wall.

The spray drying process includes spraying the encapsulating concentrate solution to contact with hot air, and vaporizing the volatile content thereof to form the wall. The acid catalyzing process includes neutralizing at least a portion of an anionic group that is included in an organic polymer compound to provide the material having solubility to water, mixing the material together with colorant in aqueous solvent, neutralizing or acidifying the material by using an acidic compound, separating the organic compound material and fixing it to the colorant, and neutralizing and dispersing the material. The phase inversion emulsion process includes using a mixture containing colorant and an anionic organic polymer having dispersibility in water as an organic solvent phase, and introducing water into the organic solvent phase or introducing the organic solvent phase into water.

Depending on the microencapsulation process used, a suitable type of the organic polymer is preferably selected. For example, when the interfacial polymerization process is used, polyester, polyamide, polyurethane, polyvinyl pyrrolidone, or epoxy resin may preferably be selected. When the in-situ polymerization process is used, a polymer or copolymer of (meth)acrylate, (meth)acrylic acid-(meth)acrylate copolymer, styrene-(meth)acrylic acid copolymer, polychlorinated vinyl, polychlorinated vinyliden, or polyamide may preferably be selected. When the in-liquid curing process is used, soda alginate, polyvinyl alcohol, gelatin, albumin, or epoxy resin may preferably be selected. When the coacervation process is used, gelatin, cellulose, or casein may preferably be used. The other encapsulation processes may also be used to obtain a fine and microencapsulated pigment.

When the phase inversion process or the acid catalyzing process is used, an anionic organic polymer is preferably selected as the organic polymer making up the wall material of the microcapsule. The phase inversion process includes preparing a compound or complex material including an anionic organic polymer having self-dispersibility or solubility in water and carbon black, or a mixture including carbon black, a curing agent, and an anionic organic polymer, as an organic solvent phase; introducing water into the organic solvent phase or introducing the organic solvent phase into water; and self-dispersing (phase inversion emulsifying) for microencapsulation. The carbon black includes a self-dispersion carbon black. According to the phase inversion process, a vehicle or an additive of the recording liquid may be mixed into the organic solvent. Particularly, it may be more preferable to mix the liquid solvent of the inkjet ink in the organic solvent so that the dispersion liquid for the inkjet ink may be directly obtained.

The acid catalyzing process includes neutralizing a portion or all of an anionic group included in an organic polymer having the anionic group, mixing the material together with a colorant such as the carbon black in an aqueous solution, neutralizing or acidifying the pH of the material by using an acidic compound to precipitate the organic polymer having the anionic group for fixing it to the colorant to obtain a hydrous cake, and neutralizing a portion or all of the anionic group by using a basic compound for microencapsulation. In this way, an aqueous dispersion liquid containing a fine anionic microcapsulated pigment having a large amount of pigment may be manufactured.

Suitable examples of the solvent used in the microencapsulation processes include, but are not limited to, alkyl alcohols such as methanol, ethanol, propanol, and butanol; aromatic alcohols such as benzyl alcohol, tolyl alcohol, and xylenol; esters such as methyl acetate, ethyl acetate, and butyl acetate; chlorinated hydrocarbons such as chloroform and ethylene dichloride; ketones such as acetone and methyl isobutyl ketone; ethers such as tetrahydrofuran and dioxane; and cellosolves such as methyl cellosolve and butyl cellosolve.

The microcapsule prepared by the aforementioned processes is separated from the solvent through centrifugal separation or filtration, and then mixed with water and a suitable solvent for re-dispersion, and thereby a recording liquid of the present invention can be obtained.

The average particle diameter of the encapsulated pigment obtained in the above manner is preferably within a range of 50 nm to 180 nm.

In the present invention, the resin coating type colorant is used in combination with a pigment that is dispersed in an aqueous solvent using the dispersant, or with a self-dispersion pigment.

The total amount of the pigment included in the resin coating type colorant of the present invention, is preferably 3.0% by mass to 10.0% by mass. When the amount of the pigment is less than 3.0% by mass, the image density may decrease. When the amount of the pigment is more than 10.0% by mass, jetting stability may decrease.

For the aforementioned dispersant, a polymer dispersant or surfactant may be used. The dispersant is not specifically limited but preferably includes an alkali metal salt or an organic salt of sodium naphthalenesulfonate formalin condensate.

For the dispersant, a water-soluble resin may be used.

Suitable examples of the water-soluble resin include, but are not limited to, block copolymer, random copolymer, or salt thereof, containing at least two monomers selected from styrene, styrene derivative, vinylnaphthalene derivative, aliphatic alcohol ester of α,β-ethylenic unsaturated carboxylic acid, acrylic acid, acrylic acid derivative, maleic acid, maleic acid derivative, itaconic acid, itaconic acid derivative, fumaric acid, and fumaric acid derivative. The water-soluble resin is an alkali soluble type resin that is soluble in the aqueous solvent in which a basic compound is dissolved. The weight-average molecular weight of the water-soluble resin is preferably 3,000 to 20,000, in terms of obtaining a dispersion liquid having low viscosity, or dispersing easily.

The aforementioned surfactant can be selected depending on the type of pigment or composition of the inkjet ink. Generally, the surfactant is classified into a nonionic surfactant, an anionic surfactant, and an amphoteric surfactant.

Suitable examples of the nonionic surfactant include, but are not limited to, polyoxyethylenealkylether such as polyoxyethylenelaurylether, polyoxyethylenemryistylyether, polyoxyethylenecetylether, polyoxyethylenestearylether, and polyoxyethyleneoleylether; polyoxyethylenealkylphenylether such as polyoxyethyleneoctylphenylether, and polyoxyethylenenonylphenylether; polyoxyethylene-α-naphthylether; polyoxyethylene-β-naphthylether; polyoxyethylenemonostyrylphenylether; polyoxyethylenedistyrylphenylether; polyoxyethylenealkylnaphthylether; polyoxyethylenemonostyrylnaphthylether; polyoxyethylenedistyrylnaphthylether.

Additional examples include, but are not limited to, surfactants such as a polyoxyethylene-polyoxypropylene block copolymer that is at least one member selected from the one listed above wherein a part of polyoxyethylene is substituted with polyoxypropylene, and a surfactant in which a compound having an aromatic ring, e.g. polyoxyethylenealkylphenylether, is condensed with formaldehyde.

The hydrophile-lipophile balance (HLB) of the nonionic surfactant is preferably 12 to 19.5, more preferably 13 to 19. When the HLB is more than 19.5 the dispersion stability may decrease, because it becomes difficult for the surfactant to absorb the pigment.

Suitable examples of the anionic surfactant include, but are not limited to, polyoxyethylenealkylether sulfate, polyoxyethylenealkylphenylether sulfate, polyoxyethylenemonostyrylphenylether sulfate, polyoxyethylenedistyrylphenylether sulfate, polyoxyethylenealkylether phosphate, polyoxyethylenealkylphenylether phosphate, polyoxyethylenemonostyrylphenylether phosphate, polyoxyethylenedistyrylphenylether phosphate, polyoxyethylenealkylether carbonate, polyoxyethylenealkylphenylether carbonate, polyoxyethylenemonostyrylphenylether carbonate, polyoxyethylenedistyrylphenylether carbonate, naphthalene sulfonate-formaldehyde condensation product, melanin sulfonate-formaldehyde condensation product, dialkylsulfosuccinate, alkyl disulfosuccinate, polyoxyethylenealkyl disulfosuccinate, alkylsulfoacetate, α-olephine sulfonate, alkylbenzenesulfonate, alkylnaphthalene sulfonate, alkyl sulfonate, N-acyl amino acid salt, acyl peptide, and soap.

The self-dispersion type pigment may be a pigment having directly or, via another group of atoms, at least one hydrophilic group on the surface thereof. Such a pigment can be stably dispersed without use of a dispersant. The pigment wherein a hydrophilic group is introduced onto the surface thereof is preferably an ionic pigment, more preferably one that is anionically or cationically charged.

Suitable examples of the anionic hydrophilic group include, but are not limited to, groups expressed as follows: —COOM, —SO₃M, —PO₃HM, —PO₃M₂, —SO₂NH₂, and —SO₂NHCOR, wherein M denotes a member selected from the group consisting of a hydrogen atom, alkali metal, ammonium, and organic ammonium, and R denotes a member selected from a C1-12 alkyl group, a substituted or unsubstituted phenyl group, and a substituted or unsubstituted naphthyl group.

Among them, a pigment having a —COOM, or —SO₃M bonded onto the surface thereof is preferred. The method for obtaining the anionically charged pigment is, for example, a method wherein a pigment is subjected to an oxidation treatment using sodium hypochlorite, a method wherein a pigment is subjected to a sulfonation treatment, a method wherein the pigment is reacted with a diazonium salt, but the method is not limited thereto.

A cationically charged hydrophilic group bonded to the surface of the color pigment is, for example, a quaternary ammonium group.

### <Water-Soluble Organic Solvent>

The water-soluble organic solvent used in the present invention includes, but is not limited to, a polyol having an equilibrium water amount of not less than 40% by mass, at 23° C. and 80% RH.

The amount of the water-soluble organic solvent is preferably from 20% by mass to 45% by mass, more preferably 32% by mass to 40% by mass. When the amount is less than 20% by mass, a printed image may have bleeding. When the amount is more than 45% by mass, the jetting stability may be reduced due to increase of viscosity.

The polyol having the equilibrium water amount of not less than 40% by mass, at 23° C. and 80% RH, preferably has a boiling point (bp) of at least 250° C. under ordinary pressure. Suitable examples thereof include, but are not limited to, 1,2,3-butanetriol, 1,2,4-butanetriol (bp 190° C. to 191° C. at 24 hPa), glycerin (bp 290° C.) diglycerin (bp 270° C. at 20 hPa), triethylene glycol (bp 285° C.), and tetraethylene glycol (bp 324° C. to 330° C.)

In the present invention, the equilibrium water amount can be obtained by measuring saturated water amount in a desiccator in which a petri dish containing 1 g of the water-soluble organic solvent is placed, wherein the interior of the desiccator is kept at 23±1° C. and 80±1% RH, by using a saturated aqueous solution of potassium chloride.

Saturated water amount (%)=(Water amount absorbed in organic solvent/organic solvent)×100

The inkjet ink may include the polyol in combination with another wetting agent. The ratio between the aforementioned polyol and the other wetting agent is not particularly limited, because it depends on the type or amount of other additives, but may be preferably 10/90 to 90/10, more preferably 40/60 to 60/40.

Suitable examples of the other wetting agent include, but are not limited to, polyols, polyol alkylethers, polyol arylethers, nitrogen-containing heterocyclic compounds, amides, amines, sulfur-containing compounds, propylene carbonate, and ethylene carbonate.

Suitable examples of the polyols include, but are not limited to, dipropylene glycol (bp 232° C.), 1,5-pentanediol (bp 242° C.), 3-methyl-1,3-butanediol (bp 203° C.), propylene glycol (bp 187° C.), 2-methyl-2,4-pentanediol (bp 197° C.), ethylene glycol (bp 196° C. to −198° C.), tripropylene glycol (bp 267° C.) hexylene glycol (bp 197° C.), polyethylene glycol (viscous liquid to solid), polypropylene glycol (bp 187° C.), 1,6-hexanediol (bp 253° C. to 260° C.), 1,2,6-hexanetriol (bp 178° C.), trimethylolethane (solid, melting point (mp) 199° C. to 201° C.), and trimethylolpropane (solid, mp 61° C.)

Suitable examples of the polyol alkyl ethers include, but are not limited to, ethylene glycol monoethyl ether (bp 135° C.), ethylene glycol monobutyl ether (bp 171° C.), diethylene glycol monomethyl ether (bp 194° C.), diethylene glycol monobutyl ether (bp 231° C.), ethylene glycol mono-2-ethylhexyl ether (bp 229° C.), and propylene glycol monoethyl ether (bp 132° C.)

Suitable examples of the polyol aryl ethers include, but are not limited to, ethylene glycol monophenyl ether (bp 237° C.) and ethylene glycol monobenzyl ether.

Suitable examples of the nitrogen-containing heterocyclic compounds include, but are not limited to, N-methyl-2-pyrrolidone (bp 202° C.), 1,3-dimethyl-2-imidazolidinone (bp 226° C.), ε-caprolactam (bp 270° C.), and γ-butyrolactone (bp 204° C. to 205° C.)

Suitable examples of the amides include, but are not limited to, formamide (bp 210° C.) N-methylformamide (bp 199° C. to 201° C.), N,N-dimethyl formamide (bp 153° C.), and N,N-diethyl formamide (bp 176° C. to 177° C.)

Suitable examples of the amines include, but are not limited to, monoethanolamine (bp 170° C.), diethanolamine (bp 268° C.), triethanolamine (bp 360° C.), N,N-dimethyl monoethanolamine (bp 139° C.), N-methyldiethanolamine (bp 243° C.), N-methylethanolamine (bp 159° C.), N-phenylethanolamine (bp 282° C. to 287° C.), and 3-aminopropyldimethylamine (bp 169° C.).

Suitable examples of the sulfur compounds include, but are not limited to, dimethylsulfoxide (bp 139° C.), sulfolan (bp 285° C.), and thiodiglycol (bp 282° C.)

Further wetting agents include saccharides.

Suitable examples of the saccharides include, but are not limited to, monosaccharides, disaccharides, oligosaccharides (including trisaccharides and tetrasaccharides), and polysaccharides. More specifically, examples of the saccharides may include glucose, mannose, fructose, ribose, xylose, arabinose, galactose, maltose, cellobiose, lactose, sucrose, trehalose, and maltotriose.

In this embodiment, the polysaccharides means sugars in a broad sense and may include substances widely present in nature, such as α-cyclodextrin and cellulose.

Derivatives of saccharides may also be employed. Suitable examples of the derivatives of saccharides include, but are not limited to, reduced sugars of the aforementioned saccharides such as sugar alcohol, expressed by a general formula HOCH₂(CHOH)ₙCH₂OH, wherein n represents an integer of 2 to 5), oxidized sugars such as aldonic acid and uronic acid, amino acids, and thio acids. Among them, sugar alcohols are preferred. Suitable examples of the sugar alcohols include, but are not limited to, maltitol and sorbitol.

### <Surfactant>

The inkjet ink of the present invention may include a surfactant. When the surfactant is used, feathering and color bleeding may be diminished, because the inkjet ink, which lands on recording media such as paper, penetrates into the recording medium immediately due to decrease of surface tension. The surface tension is preferably 20 mN/m to 35 mN/m.

The surfactant can be classified into nonionic surfactant, anionic aurfactant, and amphoteric surfactant. In addition, the surfactant can be classified into a fluorine surfactant, a silicone surfactant, and an acetylene glycol surfactant.

In the present invention, a fluorine surfactant is preferably used, however, a silicone surfactant and an acetylene glycol surfactant may be used in combination.

When the surfactant is used as penetrating agent, the amount of the surfactant added in the inkjet ink is preferably 0.05% by mass to 5% by mass, more preferably 0.1% by mass to 3% by mass.

In addition, polyols having 8 to 11 of carbon atom such as 2-ethyl-1,3-hexanediol and 2,2,2-trimethyl-1,3-pentanediol may be used in combination for increasing osmosis.

Suitable examples of the fluorine surfactants include, but are not limited to, perfluoroalkylsulfonate, perfluoroalkylcarboxylate, perfluoroalkylphosphate, perfluoroalkylethyleneoxide adducts, perfluoroalkylbetaine, and perfluoroalkylamineoxide compounds.

Examples of commercially available fluorine surfactants include, but are not limited to: Surflon S-111, S-112, S-113, S-121, S-131, S-132, S-141, S-144, and S-145 (manufactured by Asahi Glass Co., Ltd.); FLUORAD FC-93, FC-95, FC-98, FC-129, FC-135, FC-170C, FC-430, FC-431, and FC-4430 (manufactured by Sumitomo 3M Limited); Megafack F-470, F-1405, and F474 (manufactured by Dainippon Ink & Chemicals Inc.); Zonyl FS-300, FSN, FSN-100, FSO, FSO-100 (manufactured by DuPont); EFTOP EF-351, EF-352, EF-801, and EF-802 (manufactured by JEMCO Inc); FT-250 and FT251 (manufactured by NEOS COMPANY LIMITED); and PF-151N, PF-136A, PF-156A, (manufactured by OMNOVA). Among them, Zonyl FSO, FSO-100, FSN, FSN-100, and FS-300 (manufactured by DuPont) are preferred in terms of excellent printing quality and preservation stability.

Suitable examples of the nonionic surfactant include, but are not limited to, polyol, glycol ether, polyoxyethylene alkyl ether, polyoxyethylene polyoxypropylene alkyl ether, polyoxyethylene alkyl ester, polyoxyethylene sorbitan fatty acid ester, polyoxyethylene alkyl phenyl ether, polyoxyethylene alkylamine, polyoxyethylene alkylamide, and acethylene glycol.

Suitable examples of the anionic surfactant include, but are not limited to, polyoxyethylene alkyl ether sulfate, dodecylbenzene dodecylbenzenesulfonic acid, salt of lauric acid, polyoxyethylene alkyl ether sulfate.

Suitable examples of the silicone surfactant include, but are not limited to, a polyether-modified silicone compound. The polyether-modified silicone compound is classified into a side chain type (pendant type) in which polyether groups are introduced at side chains of polysiloxane, a side terminal type in which a polyether group is introduced at one terminal of polysiloxane, a both terminal type (ABA type) in which polyether groups are respectively introduced at both terminals of polysiloxane, a side-chain and both-terminal type in which polyether groups are introduced at side chains and both terminals of polysiloxane, an ABn type in which (A) polysiloxane to which a polyether group(s) is (are) introduced and (B) polysiloxane to which no polyether group is introduced are bonded in turn, and a branch type in which a polyether group(s) is (are) introduced at a terminal (s) of branched polysiloxane. The polyether-modified silicone compound for use in the present invention is preferably the side chain type (pendant type) having a structure such that polyether groups are introduced at side chains of polysiloxane.

Examples of commercially available surfactants include, but are not limited to, KF-351, KF-352A, KF-353, KF-354L, KF-355A, KF-615A, KF-945, KF-618, KF-6011, KF-6015, KF-6004 (manufactured by Shin-Etsu Chemical Co., Ltd.), SF-3771, SF-8427, SF-8428, SH-3749, SH-8400, FZ-2101, FZ-2104, FZ-2118, FZ-2203, FZ-2207, L-7604 (manufactured by Dow Corning Toray Co., Ltd.), and BYK-345, BYK-346, and BYK-348 (BKY Japan KK).

Suitable examples of the acetylene glycol surfactant include, but are not limited to, acetylene glycol such as 2,4,7,9-tetramethyl-5-decyne-4,7-diol, 3,6-dimethyl-4-octyne-3,6-diol, 3,5-dimethyl-1-hexyn-3-ol. Examples of the commercially available product thereof include SURFYNOL 104, 82, 465, 485, and TG (manufactured by Air Products and Chemicals, Inc.).

### <Additives>

The inkjet ink may optionally include one or more defoaming agents, pH adjusters, antiseptic agents, antifungal agents, antirusts, antioxidants, or ultraviolet absorbers.

The defoaming agent is not particularly limited but may include silicone defoaming agent, polyether defoaming agent, or fatty acid ester defoaming agent. These defoaming agents may be used alone or in combination of two or more. Among them, the silicone defoaming agent is preferred in terms of effect of breaking foam.

The pH adjuster is not particularly limited, as long as pH may be adjusted to not less than 7, but may include amines such as diethanolamine and triethanolamine; hydroxides of alkali metal such as lithium hydroxide, sodium hydroxide, and potassium hydroxide; carbonates of alkali metal such as lithium carbonate, sodium carbonate, and potassium carbonate; ammonium hydroxide, quaternary ammonium hydroxide, and quaternary phosphonium hydroxide.

The antiseptic agent or the antifungal agent is not particularly limited but may include 1,2-benzisothiazoline-3-on, sodium dehydroacetate, sodium sorbate, sodium 2-pyridinethiol-1-oxide, sodium benzoate, and sodium pentachlorophenol.

The antirust is not particularly limited but may include acidic sulfite, sodium thiosulfate, ammonium thiodiglycolic acid, diisopropyl ammonium nitrite, pentaerythritol tetranitrate, and dicyclohexylammonium nitrite.

The antioxidant is not particularly limited but may included phenol antioxidant including hindered phenol antioxidant, amine antioxidant, sulfur antioxidant, and phosphorus antioxidant.

The ultraviolet absorber is not particularly limited but may include oxybenzone, phenyl salicylate, and p-aminobenzoate.

### <Physical Property>

The physical property of the inkjet ink is not particularly limited and selected depending on the purpose.

The surface tension of the inkjet ink is preferably 20 mN/m to 40 mN/m at 25° C. When the surface tension is less than 20 mN/m, bleeding on the recording medium may increase, and jetting stability may decrease. When the surface tension is more than 40 mN/m, penetration of the inkjet ink into the recording medium may be inadequate, and it takes too long to dry the inkjet ink.

The pH of the inkjet ink is preferably 7 to 10.

### <Inkjet Recording Apparatus>

The inkjet ink of the present invention is applicable to use in various inkjet recording systems such as inkjet recording printers, facsimiles, copy machines, and printer/fax/copy complex machines.

Particularly, when the inkjet head of the inkjet recording apparatus has an ink repellent phase containing a fluorine series silane coupling agent or silicone resin, the inkjet ink does not adhere to the inkjet head.

A preferred embodiment of the inkjet recording apparatus of the present invention is described hereinafter.

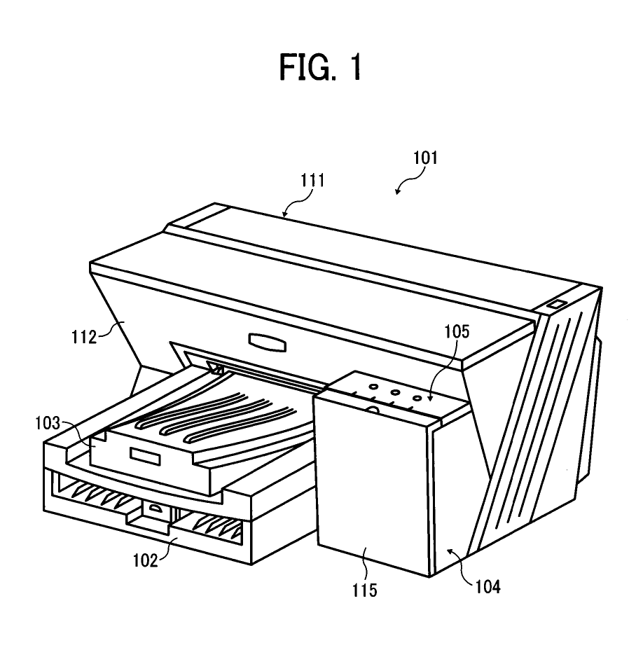

An inkjet recording apparatus shown in FIG. 1 includes an apparatus body 101, a feeder tray 102 attached to the apparatus body 101 for feeding papers, a paper output tray 103 attached to the apparatus body 101 for receiving papers on which images are recorded or formed, and an ink cartridge mounting part 104. An operation part 105 having operation keys and indicators is provided on the top surface of the ink cartridge mounting part 104. The ink cartridge mounting part 104 has front cover 115 that can be opened or closed to remove or place ink cartridges 200. In addition, the apparatus body 101 has an upside cover 111 and a forehead of the front cover 112.

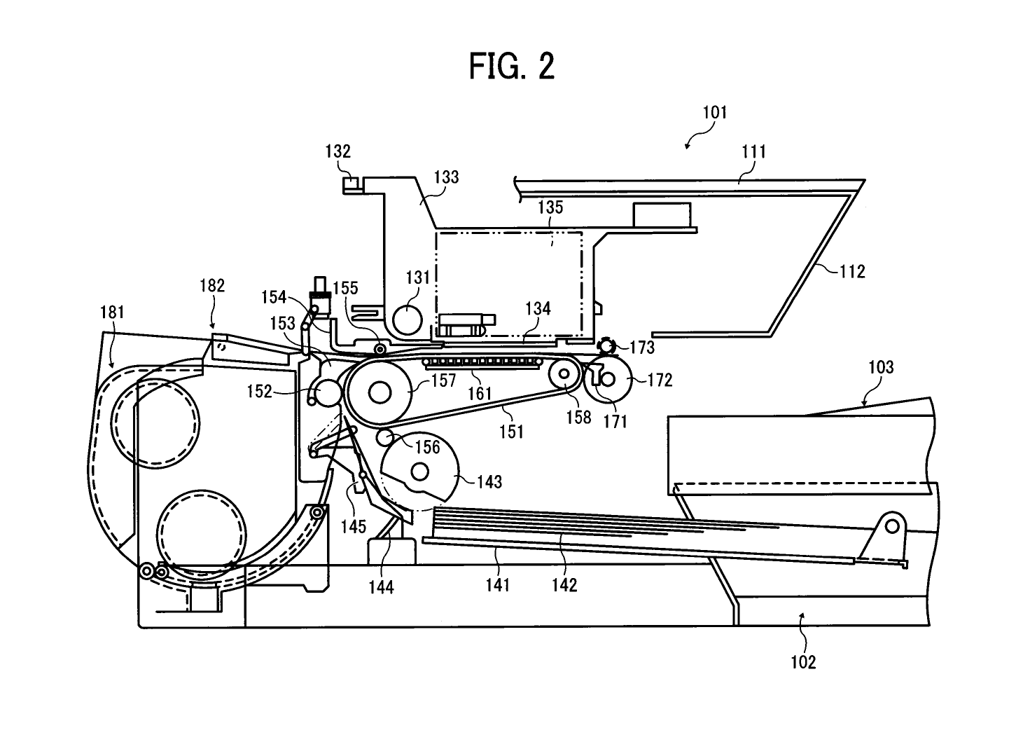

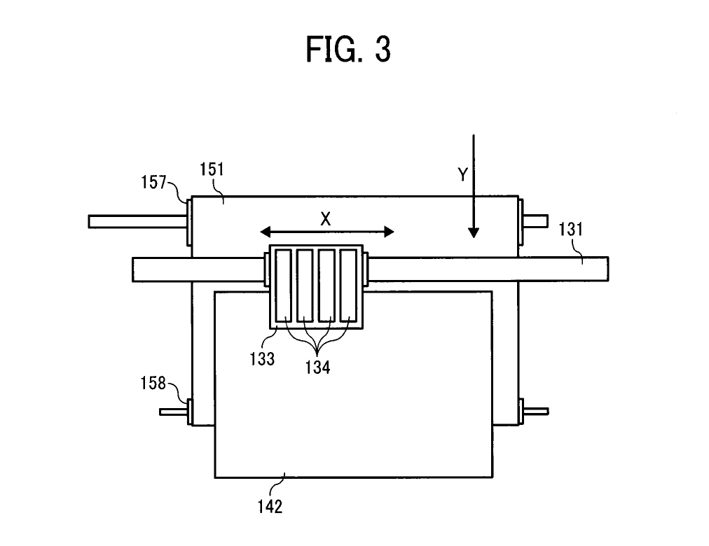

As shown in FIGS. 2 to 3, a carriage 133 is supported slidably in the scan direction by guide rod 131 that is a guide member laid across right and left side plates and stay 132 and moved by a main motor in the arrowed directions (X) for scanning within the apparatus body 101.

Recording heads 134 including four inkjet recording heads that eject yellow (Y), cyan (C), magenta (M), and black (B) recording ink droplets, respectively, have ink ejection ports arranged in the intersecting direction with the main scanning direction and they are placed in the carriage 133 with their ink ejection direction downward.

Inkjet recording heads constituting the recording heads 134 are provided with an energy generation unit for ejecting the ink, such as a piezoelectric actuator such as an piezoelectric element, a thermal actuator using an electrothermal conversion element such as an exothermic resistor to cause film boiling and, accordingly, phase change of a liquid, a shape-memory alloy actuator using metal phase changes due to temperature changes, and an electrostatic actuator using electrostatic force.

The carriage 133 is provided with subtanks 135 for supplying each color ink to the recording heads 134. The subtanks 135 are filled with the ink of the embodiment from the ink cartridge 200 mounted in the ink cartridge mounting part 105 via an ink supply tube.

A paper feed part for feeding paper 142 stuck on paper load part 141, i.e. platen, of the feed tray 102 includes a half-moon roller, i.e. feed roller 143, that separates and supplies the paper 142 from the paper load part 141 one by one and separation pad 144 that faces the feed roller 143 and is made of a large friction coefficient material. The separation pad 144 is biased toward the feed roller 143.

A conveying part for conveying the paper 142 supplied from the feed part underneath the recording heads 134 includes a conveying belt 151 for electrostatically adsorbing and conveying the paper 142, counter roller 152 for conveying the paper 142 sent from the paper feed part via guide 145 by clamping it together with the conveying belts 151, conveying guide 153 for turning the paper 142 sent nearly vertically by 90° so as to lay it on the conveying belt 151, and leading end pressure roller 155 that is biased toward the conveying belt 151 by presser member 154. Charging roller 156 that is a charging unit for charging the surface of the conveying belt 151 is also provided.

The conveying belt 151 is an endless belt, being placed over conveying roller 157 and a tension roller 158 and running around in the belt conveying direction (Y). For example, the conveying belt 151 has a front layer that is a paper adsorbing surface made of a dragging-uncontrolled resin, for example a copolymer of tetrafluoroethylene and ethylene (ETFE), having a thickness of 40 μm, and a back layer, i.e. an intermediate dragging layer or an earth layer, made of the same material as the front layer, but dragging-controlled with carbon. Guide member 161 is provided behind the conveying belt 151 at the corresponding position to the printing area by the recording heads 134. An output part for discharging the paper 142 on which recording was done by the recording heads 134 includes separation click 171 for separating the paper 142 from the conveying belt 151, paper output roller 172, and paper output roller 173. Paper output tray 103 is disposed below paper output roller 172.

Double-side feeding unit 181 is detachably mounted in the back of the apparatus body 101. The double-side feed unit 181 takes in the paper 142 that is moved backward as the conveying belt 151 is rotated in the reverse direction, turns it over, and feeds it again between the counter roller 152 and the conveying belt 151. Manual feeder 182 is provided on the top surface of the double-side feed unit 181.

In this preferred inkjet recording apparatus, the paper 142 is separated and fed from the paper feed part one by one. Being fed vertically, the paper 142 is guided by the guide 145 and conveyed between the conveying belt 151 and the counter roller 152. Then, it is guided by the conveying guide 153 at the leading end and is pressed against the conveying belt 151 by the leading end pressure roller 155 to change the convey direction substantially by 90°.

Meanwhile, the conveying belt 151 is charged by the charging roller 156, and the paper 142 is electrostatically adsorbed and conveyed by the conveying belt 151. Then, the recording heads 134 are driven according to image signals while the carriage 133 is moved. Ink droplets are ejected on the paused paper 142 for recording one-line. Then, the paper 142 is conveyed by a certain rate for recording the next line. Receiving a recording end signal or a signal indicating the rear end of the paper 142 has reached the recording area, the recording operation is terminated and the paper 142 is ejected to the paper output tray 103.

When it is detected that the remaining amount of the recording ink in the subtank 135 is nearly to the end, a certain amount of recording ink is supplied to the subtank 135 from the ink cartridge 200.

In this inkjet recording apparatus, when the recording ink in the ink cartridge 200 of the present invention is used up, the case of the ink cartridge 200 is disassembled and only the ink pouch contained therein can be exchanged. The ink cartridge 200 allows for stable recording ink supply even in a vertical and front mounting structure. Therefore, when the apparatus body 101 is installed with the top being blocked by something, for example, the ink cartridge 200 can be housed in a rack. Even if something is placed on the top surface of the apparatus body 101, the ink cartridge 200 can be easily replaced.

Here, an explanation is made with reference to an application in a serial type, i.e. shuttle type, inkjet recording apparatus in which the carriage scans is described. A line type inkjet recording apparatus having a line head is also applicable.

### <Ink Cartridge>

The ink cartridge of this embodiment includes a container containing the ink of this embodiment therein, and further includes other appropriated selected members as required.

The container is not particularly limited and its shape, structure, size, and material are appropriately selected according to the purpose. Preferred embodiments include those having at least an ink pouch formed by aluminum laminated film or resin film.

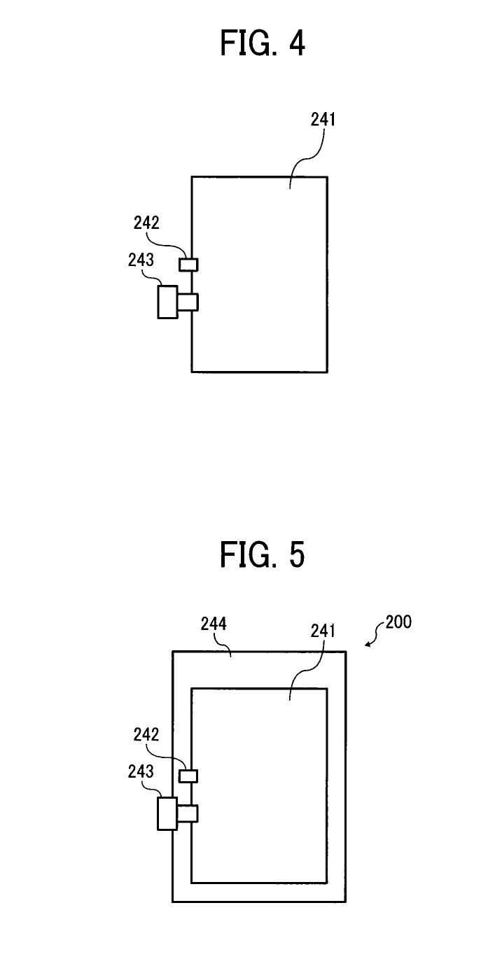

The ink cartridge is hereinafter described with reference to FIGS. 4 and 5. FIG. 1 is an illustration showing an embodiment of the ink cartridge of the present invention. FIG. 2 is an illustration of the ink cartridge of FIG. 1 including a casing, i.e. exterior.

In an ink cartridge 200, as shown in FIG. 4, an ink pouch 241 is filled through an ink inlet 242. The ink inlet 242 is closed by fusion bonding after the air is exhausted. An ink outlet 243 made of a rubber material is pierced by a needle on the apparatus body for use, thereby the ink is supplied to the apparatus. The ink pouch 241 is formed by a packaging member such as a non-permeable aluminum laminated film. The ink pouch 241 is housed in a cartridge case 244 generally made of plastics as shown in FIG. 2 and detachably mounted on various types of inkjet recording apparatus.

The ink cartridge 200 can be detachably mounted on variety types of inkjet recording apparatus and it is particularly preferable that the ink cartridge 200 is detachably mounted on the inkjet recording apparatus of the embodiments described herein.

### EXAMPLES

The present invention will be more specifically explained with reference to Examples and Comparative Examples, but Examples shall not be construed so as to limit the scope of the present invention in any way.

### (Preparation of Resin Coating Type Black Pigment Dispersion Liquid)

The interior of a 1-L flask equipped with a mechanical stirrer, a thermometer, a nitrogen gas introduction tube, a reflux tube, and a dropping funnel is satisfactorily replaced by nitrogen gas. The flask is charged with 11.2 g of styrene, 2.8 g of acrylic acid, 12.0 g of lauryl methacrylate, 4.0 g of polyethylene glycol methacrylate, 4.0 g of styrene macromer (trade name: AS-6 manufactured by Toa Gosei Chemical Industry Co., Ltd.,), and 0.4 g of mercapto ethanol, and the temperature of the flask is raised to 65° C.

A liquid mixture including 100.8 g of styrene, 25.2 g of acrylic acid, 108.0 g of lauryl methacrylate, 36.0 g of polyethylene glycol methacrylate, 60.0 g of hydroxyethyl methacrylate, 36.0 g of styrene macromer, 3.6 g of mercapto ethanol, 2.4 g of azobisdimethylvaleronitrile, and 18 g of methyl ethyl ketone is then added dropwise into the flask over a period of 2.5 hr.

After the completion of the dropwise addition, a mixed solution composed of 0.8 g of azobisdimethylvaleronitrile and 18 g of methyl ethyl ketone is added dropwise into the flask over a period of 0.5 hr. The mixture is aged at 65° C. for 1 hr. To the resultant, 0.8 g of azobisdimethylvaleronitrile is then added, and the resulting mixture is aged for additional 1 hr. After the completion of the reaction, 364 g of methyl ethyl ketone is added into the flask to prepare 800 g of a polymer solution having a concentration of 50% by mass. A part of the polymer solution is dried, and then the weight-average molecular weight is measured by gel permeation chromatography (standard: polystyrene, solvent: tetrahydrofuran). The weight-average molecular weight obtained is 150,000.

The polymer solution synthesized above (28 g), 26 g of carbon black, 13.6 g of a 1 mol/L potassium hydroxide solution, 20 g of methyl ethyl ketone, and 30 g of ion exchanged water are satisfactorily stirred, and the mixture is then kneaded with a three-roll mill (trade name: NR-84A manufactured by Noritake Co., Limited). The resultant paste is introduced into 200 g of ion exchanged water, and the mixture is satisfactorily stirred. Methyl ethyl ketone and a part of the water are removed by distillation with an evaporator to obtain resin coating type black pigment dispersion liquid 1.

### (Pigment Dispersion Liquid A-1)

Carbon black, NIPEX160, having BET specific surface area of 150 m²/g, average primary particle size of 20 nm, pH of 4.0, DBP oil absorption of 620 g/100 g, manufactured by Degussa . . . 175 parts

Sodium naphthalenesulfonate formalin condensate, PIONIN A-45-PN, manufactured by TAKEMOTO OIL & FAT Co., Ltd., total amount of naphthalenesulfonate dimmer, trimer, and tetramer is 50% . . . 175 parts

Purified water . . . 650 parts

This aforementioned mixture is preliminarily mixed to obtain mixed slurry. Then, the mixture is dispersed by disk-type media mill, DMR typ, manufatcuted by Ashizawa Finetech Ltd., using 0.05 mm diameter Zirconia bead with rim speed of 10 m/sat liquid temperature of 10° C. and filling rate of 55%, for 3 minutes. Next, coarse particles are separated by centrifugation using centrifugal machine Model-7700, manufactured by KUBOTA Corporation, to obtain surfactant dispersion type pigment dispersion liquid 2 having pigment concentration of 13% by mass.

### Example 1

Pigment dispersion liquid 1 . . . 50% by mass

Urethane resin emulsion 1, W5025, manufactured by Mitsui Chemicals, Inc., anionic self-emulsification type ether-based polyurethane emulsion resin, having polyurethane particle content of 30% by mass, average particle diameter (D50) of 10 nm, weight-average molecular weight of 2.0×10⁴, acid value of 70 mgKOH/g, viscosity of 211 mPa·s at 25° C. . . . 0.6% by mass

3-Methyl-1,3-butanediol . . . 15% by mass

Glycerin 15% by mass

Water remaining amount

The aforementioned water-soluble organic solvent (wetting agent), surfactant, and water are mixed uniformly for 1 hour. The urethane resin emulsion 1 is added to the mixture, and then mixed for 1 hour. Next, the pigment dispersion liquid 1 is added to the mixture, then mixed for 1 hour. Coarse particles and foreign particles are separated by pressure filtration using polyvinylidene fluoride membrane filter having an average pore diameter of 5.0 μm to obtain inkjet ink 1.

### Example 2

Inkjet ink 2 is obtained in the same manner as in example 1, provided that the amount of 3-methyl-1,3-buthanediol and glycerin are changed to 9% by mass respectively.

### Example 3

Inkjet ink 3 is obtained in the same manner as in example 1, provided that the amount of 3-methyl-1,3-buthanediol and glycerin are changed to 13% by mass respectively.

### Example 4

Inkjet ink 4 is obtained in the same manner as in example 1, provided that the amount of 3-methyl-1,3-buthanediol and glycerin are changed to 16% by mass respectively.

### Example 5

Inkjet ink 5 is obtained in the same manner as in example 1, provided that the amount of 3-methyl-1,3-buthanediol and glycerin are changed to 18% by mass respectively.

### Example 6

Inkjet ink 6 is obtained in the same manner as in example 1, provided that the amount of urethane resin emulsion 1 is changed to 0.15% by mass.

### Example 7

Inkjet ink 7 is obtained in the same manner as in example 1, provided that the amount of urethane resin emulsion 1 is changed to 0.45% by mass.

### Example 8

Inkjet ink 8 is obtained in the same manner as in example 1, provided that the amount of urethane resin emulsion 1 is changed to 2.85% by mass.

### Example 9

Inkjet ink 9 is obtained in the same manner as in example 1, provided that the amount of urethane resin emulsion 1 is changed to 4.50% by mass.

### Example 10

Inkjet ink 10 is obtained in the same manner as in example 1, provided that the urethane resin emulsion 1 is replaced by urethane resin emulsion 2.

### (Urethane Resin Emulsion 2)

Anionic self-emulsification type ether-based polyurethane emulsion resin, W5661, manufactured by

Mitsui Chemicals, Inc., having polyurethane particle content of 30% by mass, average particle diameter (D50) of 11 nm, weight-average molecular weight of 1.5×10⁴, acid value of 50 mgKOH/g, viscosity of 405 mPa·s at 25° C.

### Example 11

Inkjet ink 11 is obtained in the same manner as in example 1, provided that the pigment dispersion liquid 1 is replaced by 45% by mass of pigment dispersion liquid 1 and 5% by mass of pigment dispersion liquid 2.

### Example 12

Inkjet ink 12 is obtained in the same manner as in example 1, provided that the pigment dispersion liquid 1 is replaced by 40% by mass of pigment dispersion liquid 1 and 10% by mass of pigment dispersion liquid 2.

### Example 13

Inkjet ink 13 is obtained in the same manner as in example 1, provided that the pigment dispersion liquid 1 is replaced by 35% by mass of pigment dispersion liquid 1 and 15% by mass of pigment dispersion liquid 2.

### Example 14

Inkjet ink 14 is obtained in the same manner as in example 1, provided that the pigment dispersion liquid 1 is replaced by 30% by mass of pigment dispersion liquid 1 and 20% by mass of pigment dispersion liquid 2.

### Example 15

Inkjet ink 15 is obtained in the same manner as in example 1, provided that the pigment dispersion liquid 1 is replaced by 45% by mass of pigment dispersion liquid 1 and 5% by mass of self-dispersion type pigment dispersion liquid described below.

### (Self-Dispersion Pigment Dispersion Liquid)

KM-9036, manufactured by TOYO INK CO., LTD., number of the coarse particle, which the particle diameter is not less than 0.5 μm, is 7.2×10⁵, and the number of the coarse particle, which the particle diameter is not less than 1.0 μm, is 2.4×10³, measured by Accu Sizer 780, the particle diameter is manufactured by Particle Sizing Systems.

### Example 16

Inkjet ink 16 is obtained in the same manner as in example 1, provided that a further 0.4% by mass of the surfactant which is described below is added.

### (Surfactant)

Zonyl FS-300, manufactured by DuPont, having 40% by mass of polyoxyethylene perfluorooalkyl ether.

### Example 17

Inkjet ink 17 is obtained in the same manner as in example 16, provided that the amount of the surfactant is changed to 5.0% by mass.

### Example 18

Inkjet ink 18 is obtained in the same manner as in example 16, provided that the amount of the surfactant is changed to 0.2% by mass.

### Example 19

Inkjet ink 19 is obtained in the same manner as in example 16, provided that the amount of the surfactant is changed to 9.0% by mass.

### Comparative Example 1

Inkjet ink 20 is obtained in the same manner as in example 1, provided that the pigment dispersion liquid 1 is replaced by 50% by mass of the aforementioned self-dispersion pigment dispersion liquid.

### Comparative Example 1

Inkjet ink 21 is obtained in the same manner as in example 1, provided that urethane resin emulsion 1 is not used.

### Comparative Example 3

Inkjet ink 22 is obtained in the same manner as in example 1, provided that 50% by mass of the pigment dispersion liquid 1 is replaced by 10% by mass of pigment dispersion liquid 1 and 40% by mass of pigment dispersion liquid 2, and further the amount of urethane resin emulsion 1 is changed to 10% by mass.

### Comparative Example 4

Inkjet ink 23 is obtained in the same manner as in example 1, provided that the 50% by mass of pigment dispersion liquid 1 is replaced by 50% by mass of pigment dispersion liquid 2, and further the amount of urethane resin emulsion 1 is changed to 10% by mass.

The compositions of inkjet inks 1 to 23 are shown in Tables 1 to 4.

TABLE.1

| Component | | | | | | |
|---|---|---|---|---|---|---|
| (% by mass) | Ex. 1 | Ex. 2 | Ex. 3 | Ex. 4 | Ex. 5 | Ex. 6 |
| Pigment | 50.0 | 50.0 | 50.0 | 50.0 | 50.0 | 50.0 |
| dispersion | | | | | | |
| liquid 1 | | | | | | |
| Pigment | | | | | | |
| dispersion | | | | | | |
| liquid 2 | | | | | | |
| Self-dispersion | | | | | | |
| pigment | | | | | | |
| dispersion | | | | | | |
| liquid | | | | | | |
| Urethane resin | 0.60 | 0.60 | 0.60 | 0.60 | 0.60 | 0.15 |
| emulsion 1 | | | | | | |
| Urethane resin | | | | | | |
| emulsion 2 | | | | | | |
| Surfactant | | | | | | |
| 3-methyl-1,3- | 15.0 | 9.0 | 13.0 | 16.0 | 18.0 | 15.0 |
| butanediol | | | | | | |
| Glycerin | 15.0 | 9.0 | 13.0 | 16.0 | 18.0 | 15.0 |
| Purified water | rest | rest | rest | rest | rest | rest |
| Total | 100 | 100 | 100 | 100 | 100 | 100 |
| (% by mass) | | | | | | |

TABLE 2

| Component | | | | Ex. | Ex. | Ex. |
|---|---|---|---|---|---|---|
| (% by mass) | Ex. 7 | Ex. 8 | Ex. 9 | 10 | 11 | 12 |
| Pigment | 50.0 | 50.0 | 50.0 | 50.0 | 45.0 | 40.0 |
| dispersion | | | | | | |
| liquid 1 | | | | | | |
| Pigment | | | | | 5.0 | 10.0 |
| dispersion | | | | | | |
| liquid 2 | | | | | | |
| Self-dispersion | | | | | | |
| pigment | | | | | | |
| dispersion | | | | | | |
| liquid | | | | | | |
| Urethane resin | 0.45 | 2.85 | 4.50 | | 0.60 | 0.60 |
| emulsion 1 | | | | | | |
| Urethane resin | | | | 0.60 | | |
| emulsion 2 | | | | | | |
| Surfactant | | | | | | |
| 3-methyl-1,3- | 15.0 | 15.0 | 15.0 | 15.0 | 15.0 | 15.0 |
| butanediol | | | | | | |
| Glycerin | 15.0 | 15.0 | 15.0 | 15.0 | 15.0 | 15.0 |
| Purified water | rest | rest | rest | rest | rest | rest |
| Total | 100 | 100 | 100 | 100 | 100 | 100 |
| (% by mass) | | | | | | |

TABLE 3

| Component | Ex. | Ex. | Ex. | Ex. | Ex. | Ex. | Ex. |
|---|---|---|---|---|---|---|---|
| (% by mass) | 13 | 14 | 15 | 16 | 17 | 18 | 19 |
| Pigment Dispersion | 35.0 | 30.0 | 45.0 | 50.0 | 50.0 | 50.0 | 50.0 |
| liquid 1 | | | | | | | |
| Pigment dispersion | 15.0 | 20.0 | | | | | |
| liquid 2 | | | | | | | |
| Self-dispersion | | | 5.0 | | | | |
| pigment | | | | | | | |
| dispersion liquid | | | | | | | |
| Urethane resin | 0.60 | 0.60 | 0.60 | 0.60 | 0.60 | 0.60 | 0.60 |
| emulsion 1 | | | | | | | |
| Urethane resin | | | | | | | |
| emulsion 2 | | | | | | | |
| Surfactant | | | | 0.4 | 5.0 | 0.2 | 9.0 |
| 3-methyl-1,3-butanediol | 15.0 | 15.0 | 15.0 | 15.0 | 15.0 | 15.0 | 15.0 |
| Glycerin | 15.0 | 15.0 | 15.0 | 15.0 | 15.0 | 15.0 | 15.0 |
| Purified water | rest | rest | rest | rest | rest | rest | rest |
| Total (% by mass) | 100 | 100 | 100 | 100 | 100 | 100 | 100 |

TABLE 4

| Component | Co. Ex. | Co. Ex. | Co. Ex. | Co. Ex. |
|---|---|---|---|---|
| (% by mass) | 1 | 2 | 3 | 4 |
| Pigment dispersion | | 50.0 | 10.0 | |
| liquid 1 | | | | |
| Pigment dispersion | | | 40.0 | 50.0 |
| liquid 2 | | | | |
| Self-dispersion | 50.0 | | | |
| pigment | | | | |
| dispersion liquid | | | | |
| Urethane resin | 0.60 | | 10.0 | 10.0 |
| Emulsion 1 | | | | |
| Urethane resin | | | | |
| emulsion 2 | | | | |
| Surfactant | | | | |
| 3-methyl-1,3-butanediol | 15.0 | 15.0 | 15.0 | 15.0 |
| Glycerin | 15.0 | 15.0 | 15.0 | 15.0 |
| Purified water | rest | rest | rest | rest |
| Total (% by mass) | 100 | 100 | 100 | 100 |

Inkjet inks 1 to 23 are evaluated using the method described below. The results are shown in table 5 to 8.

TABLE 5

| | Viscosity | D(INI) | D(60%) | D(60%)/ |
|---|---|---|---|---|
| | (mPa · S) | (nm) | (nm) | D(INI) |
| Ex. 1 | 7.9 | 84.3 | 86.0 | 1.04 |
| Ex. 2 | 3.0 | 82.1 | 82.5 | 1.00 |
| Ex. 3 | 6.4 | 87.6 | 92.0 | 1.05 |
| Ex. 4 | 11.1 | 88.0 | 93.3 | 1.06 |
| Ex. 5 | 14.8 | 90.3 | 101.1 | 1.12 |
| Ex. 6 | 7.6 | 82.0 | 82.8 | 1.01 |
| Ex. 7 | 7.8 | 83.4 | 85.9 | 1.03 |
| Ex. 8 | 8.3 | 85.5 | 101.7 | 1.19 |
| Ex. 9 | 8.7 | 90.7 | 113.4 | 1.25 |
| Ex. 10 | 8.3 | 90.9 | 95.4 | 1.05 |
| Ex. 11 | 7.9 | 95.0 | 97.9 | 1.03 |
| Ex. 12 | 7.8 | 89.3 | 94.7 | 1.06 |
| Ex. 13 | 7.9 | 94.2 | 116.8 | 1.24 |
| Ex. 14 | 7.7 | 97.5 | 125.8 | 1.29 |
| Ex. 15 | 8.1 | 89.9 | 98.0 | 1.09 |
| Ex. 16 | 8.0 | 85.0 | 90.1 | 1.06 |
| Ex. 17 | 8.0 | 84.3 | 87.7 | 1.04 |
| Ex. 18 | 8.2 | 83.5 | 84.3 | 1.01 |
| Ex. 19 | 8.1 | 83.1 | 90.6 | 1.09 |

TABLE 6

| | Image | abrasion- | Jetting | |
|---|---|---|---|---|
| | Density | resistant | Stability | Bleeding |
| Ex. 1 | A | A | B | B |
| Ex. 2 | B | B | A | B |
| Ex. 3 | A | B | A | B |
| Ex. 4 | A | A | B | A |
| Ex. 5 | A | A | B | A |
| Ex. 6 | A | B | A | B |
| Ex. 7 | A | A | A | B |
| Ex. 8 | B | A | A | B |
| Ex. 9 | B | A | B | A |
| Ex. 10 | A | A | B | B |
| Ex. 11 | A | A | A | B |
| Ex. 12 | A | A | A | B |
| Ex. 13 | A | A | B | B |
| Ex. 14 | B | A | B | B |
| Ex. 15 | A | B | B | B |
| Ex. 16 | A | A | A | B |
| Ex. 17 | A | A | A | A |
| Ex. 18 | A | A | A | A |
| Ex. 19 | A | A | B | A |

TABLE 7

| | Viscosity | D(INI) | D(60%) | D(60%)/ |
|---|---|---|---|---|
| | (mPa · S) | (nm) | (nm) | D(INI) |
| Co. Ex. 1 | 8.5 | 108.1 | 114.6 | 1.06 |
| Co. Ex. 2 | 7.7 | 82.7 | 85.2 | 1.03 |
| Co. Ex. 3 | 9.1 | 98.9 | 143.4 | 1.45 |
| Co. Ex. 4 | 8.7 | 101.0 | 136.4 | 1.35 |

TABLE 8

| | Image | abrasion- | Jetting | |
|---|---|---|---|---|
| | Density | resistant | Stability | Bleeding |
| Co. Ex. 1 | C | D | B | D |
| Co. Ex. 2 | A | D | A | D |
| Co. Ex. 3 | C | A | D | B |
| Co. Ex. 4 | A | A | D | B |

### <Viscosity>

The viscosity of the inkjet ink is measured by using viscometer, RE80L, manufactured by TOKI SANGYO CO., LTD., at 25° C.

### <Average Particle Diameter (D50)>

The average particle diameter of the inkjet ink in initial state, D50(INI), and the average particle diameter of the inkjet ink in dried state, having 60% by mass of the initial state, D50 (60), are measured by using microtrac UPA-150 manufactured by NIKKISO CO., LTD., wherein the solid content concentration of the sample for measurement is adjusted to 0.01% by mass, in consideration that the inkjet ink in the nozzle is mixed with fresh inkjet ink having low viscosity in ejecting.

### <Preparation of Printing Evaluation>

The inkjet printer (IPSiO GX3000, manufactured by Ricoh Company Limited) is set to eject the same amount of the inkjet ink to recorsing medium by varying the driving voltage of a piezo element.

The property of the inkjet ink is evaluated under the environment (MM) adjusted to at 25±0.5° C., and 50±5% RH, unless the jetting stability is evaluated under the environment (HL) adjusted to at 32±0.5° C., and 15±5% RH.

### <Image Density>

A chart, in which a 64 point black character “▪” is printed using Microsoft Word 2003 (manufactured by Microsoft Corporation) on My Paper (manufactured by Ricoh Company Limited) having basis weight of 69.6 g/m², size of 23.238 s, and air permeability of 21.0 s, was prepared. OD value (optical density) of the area where the character “▪” was printed is measured by means of X-Rite938, and image density is evaluated based on the following evaluation criteria.

The printing mode used is set to plain paper, standard, and fast speed by the driver attached to the printer.

### (Evaluation Criteria)

A: not less than 1.20

B: 1.10 or more but less than 1.20

C: 1.00 or more but less than 1.10

D: less than 1.00

### <Abrasion-Resistant>

A chart, in which a black solid image is formed, is printed at resolution of 600 dpi on My Paper (manufactured by Ricoh Company Limited) having basis weight of 71.7 g/m², size of 20.0 s, and air permeability of 22.5 s.

After the printed image is dried, the area where the image is printed is scratched for 10 times by cotton cloth. The abrasion-resistant is evaluated based on the degree of pigment transition to the cotton cloth by visual observation.

### (Evaluation Criteria)

A: pigment transition is not observed wholly
B: pigment transition is slightly observed but acceptable
C: pigment transition is clearly observed

### <Jetting Stability>

The inkjet ink is left under the environment (HL) at 32±0.5° C., and 15±5% RH for 3 hours. Next, each of the inkjet inks 1 to 23 is filled into an ink cartridge, and then 1 piece of nozzle check pattern including solid image is printed on My Paper (manufactured by Ricoh Company Limited) having basis weight of 69.6 g/m², size of 23.2 s, and air permeability of 21.0 s. In this case, dead pixel is not observed.

Then inkjet printer is left under the environment (HL) at 32±0.5° C., and 15±5% RH for 6 days. Next, 1 piece of the nozzle check pattern including solid image is printed again on My Paper (manufactured by Ricoh Company Limited) having basis weight of 69.6 g/m², size of 23.2 s, and air permeability of 21.0 s, and then existence of dead pixel or flection in flight is confirmed.

When the dead pixel or the flection in flight is observed, a cleaning operation of the nozzle is performed. The jetting stability is evaluated based on the number of cleaning operations, in which the ink-ejection level of the printer is adjusted to the initial ink-ejection level.

### [Evaluation Criteria]

A: Ink-ejection level is adjusted to the initial level with zero or one cleaning time

B: Ink-ejection level is adjusted to the initial level with two to five cleaning times

D: Ink-ejection level is not adjusted to the initial ink-ejection level even with five or more cleaning times

### <Bleeding>

A chart on which 9 point symbol “Todoroki” in Kanji, formed using Microsoft Word 2003 (by Microsoft Corporation), is printed on Type 6200 (manufactured by Ricoh Company Limited), and then visually observed to determine whether Bleeding occurred.

### [Evaluation Criteria]

A: No problem occurs.

B: Feathering slightly occurs but no problem occurs.

D: Feathering occurs and problem occurs.

What is claimed is:

1. An inkjet ink comprising:
water;
a water-soluble organic solvent;
a colorant comprising a resin coating type colorant; and
a resin emulsion comprising an anionic polyurethane resin emulsion,
wherein the inkjet ink in an initial state has an average particle diameter D50 (INI), and the inkjet ink in a dried state having 60% by mass of the initial state has an average particle diameter D50(60%), such that the inkjet ink satisfies the following formula:
1.00≦D50(60%)/D50(INI)<1.30.

2. The inkjet ink according to claim 1, wherein inkjet ink satisfies the following formula:
1.00≦D50(60%)/D50(INI)<1.10.

3. The inkjet ink according to claim 1, wherein the inkjet ink has a viscosity of 5 mPa·s to 12 mPa·s.

4. The inkjet ink according to claim 1, wherein the resin emulsion is present in an amount of 0.10% by mass to 1.00% by mass.

5. The inkjet ink according to claim 1, wherein the inkjet ink further comprises 0.1% by mass to 3.0% by mass of a fluorine surfactant.

6. The inkjet ink according to claim 1, wherein the colorant comprises not more than 45% by mass of a pigment, wherein the pigment is selected from a self-dispersion type pigment, and the pigment is dispersed in an aqueous solvent using a high molecular weight dispersant or a surfactant.

7. The inkjet ink according to claim 1, wherein the inkjet ink further comprises at least one member selected from the group consisting of defoaming agents, pH adjusters, antiseptic agents, antifungal agents, antirusts, antioxidants, and ultraviolet absorbers.

8. The inkjet ink according to claim 5, wherein the fluorine surfactant is at least one member selected from the group consisting of perfluoroalkylsulfonates, perfluoroalkylcarboxylates, perfluoroalkylphosphates, perfluoroalkylethyleneoxide adducts, perfluoroalkylbetaines, and perfluoroalkylamineoxide compounds.

9. The inkjet ink according to claim 1, wherein the colorant comprises at least one dye selected from the group consisting of acid dyes, edible dyes, direct dyes, basic dyes, and reactive dyes.

10. The inkjet ink according to claim 1, wherein the polyurethane resin emulsion is an O/W emulsion.

11. The inkjet ink according to claim 1, wherein the polyurethane resin in the polyurethane resin emulsion has a weight-average molecular weight of from 1.3×10⁴ to 3.0×10⁴.

12. The inkjet ink according to claim 6, wherein the pigment has an average particle diameter of from 10 nm to 150 nm.

13. The inkjet ink according to claim 1, wherein the resin coating type colorant comprises a resin forming the coating that is at least one member selected from the group consisting of polyamide, polyurethane, polyester, polyurea, epoxy resin, polycarbonate, urea resin, melamine resin, phenol resin, polysaccharides, gelatin, Arabian gum, dextran, casein, protein, natural rubber, carboxy polymethylene, polyvinyl alcohol, polyvinyl pyrrolidone, polyvinyl acetate, polyvinyl chloride, polyvinylidene chloride, cellulose, ethylcellulose, methylcellulose, nitrocellulose, hydroxyethylcellulose, cellulose acetate, polyethylene, polystyrene, polymer or copolymer of (meth)acrylic acid, polymer or copolymer of (meth)acrylate, (meth)acrylic acid-(meth)acrylate copolymer, styrene-(meth)acrylic acid copolymer, styrene-maleic acid copolymer, sodium alginate, fatty acid, paraffin, bees wax, insect wax, cured beef tallow, carnauba wax, and albumin.

14. An ink cartridge comprising:
a container containing the inkjet ink as defined in claim 1.
